(19) United States
(12) Patent Application Publication
(10) Pub. No.: US 2020/0079299 A1
(43) Pub. Date: Mar. 12, 2020

(54) VEHICLE POWER OUTLET

(71) Applicant: Ford Global Technologies, LLC, Dearborn, MI (US)

(72) Inventors: Stuart C. Salter, White Lake, MI (US); Kent Harrison, Northville, MI (US); Annette Lynn Huebner, White Lake, MI (US); David Brian Glickman, Southfield, MI (US); Paul Kenneth Dellock, Northville, MI (US)

(21) Appl. No.: 16/124,531

(22) Filed: Sep. 7, 2018

(51) Int. Cl. B60R 16/02; B60Q 1/30; B60K 25/02; H01R 13/447

(52) U.S. Cl. CPC B60R 16/02; B60Q 1/30; H01R 2201/26; H01R 13/447; B60K 25/02

(57) ABSTRACT

An exemplary vehicle outlet assembly includes, among other things, an outlet mounted to a vehicle, a cover moveable between a covering position where the cover conceals the outlet and an accessing position where the cover reveals the outlet. The assembly further includes at least one side shield that extends transversely from the cover to the outlet when the cover is in the accessing position. An exemplary power providing method includes powering a device through an outlet of a vehicle and illuminating an area associated with the device during the powering using at least one light of the vehicle.

### TECHNICAL FIELD

This disclosure relates generally to a power outlet of a vehicle and, more particularly, to a power outlet that provides power generated by a generator of the vehicle to a load that is external to a vehicle.

### BACKGROUND

Some vehicles include a power outlet. A generator of the vehicle can operate to provide power to the power outlet. A user can power loads external to the vehicle through the power outlet.

The power outlet can be particularly useful for commercial vehicles and work trucks that are often at job sites and other areas lacking a grid power source. When at a job site, a user can power tools and other devices through the power outlet of the vehicle.

The generator providing power to the power outlet can be driven by an internal combustion engine of the vehicle. Some vehicles, such as electrified vehicles, can instead, or additionally, drive the generator using power from a battery. Electrified vehicles differ from conventional motor vehicles because electrified vehicles are selectively driven using one or more electric machines powered by a traction battery. In such vehicles, the traction battery can power the generator to provide power to the outlet. The traction battery could also power the outlet directly without relying on the generator.

### SUMMARY

A vehicle outlet assembly according to an exemplary aspect of the present disclosure includes, among other things, an outlet mounted to a vehicle, and a cover moveable between a covering position where the cover conceals the outlet and an accessing position where the cover reveals the outlet. The assembly further includes at least one side shield that extends transversely from the cover to the outlet when the cover is in the accessing position.

In another example of the foregoing assembly, the cover is configured to pivot between the covering and accessing positions about a cover pivot axis that is vertically above the outlet. The at least one side shield includes a side shield configured to pivot about a shield axis on a passenger side of the outlet, and a side shield configured to pivot about a shield axis on a driver side of the outlet.

In another example of any of the foregoing assemblies, the at least one side shield is at least partially received within a slot of the vehicle when the cover is in the covering position.

In another example of any of the foregoing assemblies, the at least one shield includes a first shield on a passenger side of the outlet and a second shield on a driver side of the outlet.

Another example of any of the foregoing assemblies includes a cord hook extending from an underside of the cover.

In another example of any of the foregoing assemblies, the outlet is positioned on the vehicle at an interface between a moveable panel of the vehicle and a stationary panel of the vehicle.

In another example of any of the foregoing assemblies, the moveable panel is a liftgate of the vehicle.

Another example of any of the foregoing assemblies includes lights of the vehicle. The lights are configured to indicate a status of the outlet.

Another example of any of the foregoing assemblies includes backup lights of the vehicle. The backup lights are configured to illuminate when power is provided to the outlet.

Another example of any of the foregoing assemblies includes a controller module configured to initiate a transmission of an alert that provides an indication to a user of available power that can be drawn through the outlet.

Another example of any of the foregoing assemblies includes a controller module configured to cause an interruption in power flow to the outlet in response to an amount of fuel in the vehicle being reduced to below a threshold value.

In another example of any of the foregoing assemblies, the outlet is a 220 Volt outlet.

A power providing method according to another exemplary aspect of the present disclosure includes powering a device through an outlet of a vehicle and illuminating an area associated with the device during the powering using at least one light of the vehicle.

In another example of the foregoing method, the at least one light is a backup light of the vehicle.

Another example of any of the foregoing methods includes stopping the powering in response to an amount of fuel being reduced below a threshold value that is greater than zero.

Another example of any of the foregoing methods includes stopping the powering in response to an amount of charge in a battery being reduced below a threshold value that is greater than zero.

Another example of any of the foregoing methods includes alerting a user in response to an amount of power available for powering being reduced to below a threshold value that is greater than zero.

In another example of any of the foregoing methods, the illuminating is in response to the powering.

Another example of any of the foregoing methods includes transmitting an alert that provides an indication to a user of available power that can be drawn through the outlet.

Another example of any of the foregoing methods includes, prior to the powering, moving a cover from a covering position where the cover conceals the outlet to an accessing position where the cover reveals the outlet. At least one side shield extends transversely from the cover to the outlet when the cover is in the accessing position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a rear view of an example vehicle having an outlet assembly used to power an auxiliary load.

FIG. 2 illustrates a close-up, perspective view of the power outlet assembly when a cover of the power outlet assembly is in an accessing position and with one of the side shields removed for clarity.

FIG. 3 illustrates a side view of the power outlet assembly of FIG. 2.

FIG. 4 illustrates a highly schematic view of the vehicle of FIG. 1.

FIG. 5 illustrates a section view of the power outlet assembly at line 5-5 in FIG. 3.

FIG. 6 illustrates a section view of the power outlet assembly at line 5-5 when the cover is in the covering position.

FIG. 7 illustrates a perspective view of a power outlet assembly according to another exemplary embodiment when a cover of the power outlet assembly is in an accessing position.

FIG. 8 illustrates a schematic view of a control module of the vehicle of FIG. 1 in communication with other areas of the vehicle and other areas outside the vehicle.

### DETAILED DESCRIPTION

This disclosure relates generally to a power outlet of a vehicle. The power outlet can be considered an auxiliary power unit as the power outlet can be used to power loads outside the vehicle. Exemplary loads could include power tools at a job site, for example. An electrified vehicle or a conventional vehicle can include the power outlet.

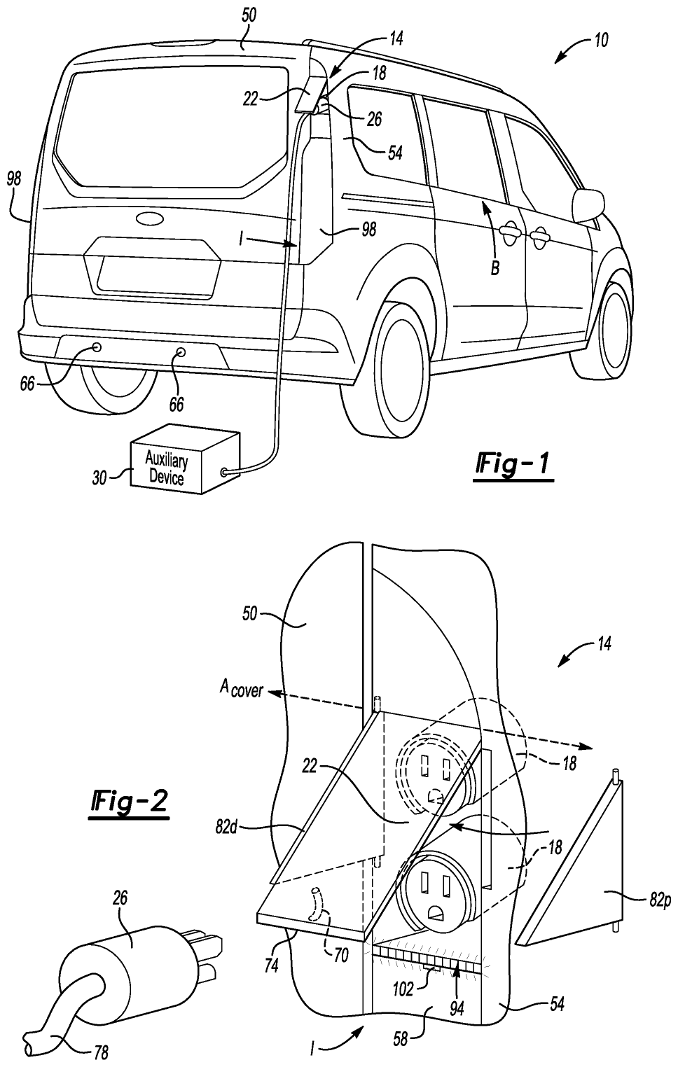

With reference to FIGS. 1-3, a rear area of a vehicle 10 includes an outlet assembly 14. Among other things, the outlet assembly 14 includes at least one outlet 18 and a cover 22. The cover 22 is shown in an accessing position. A user can couple a plug 26 of an auxiliary device 30 to the outlet 18 when the cover is in the accessing position.

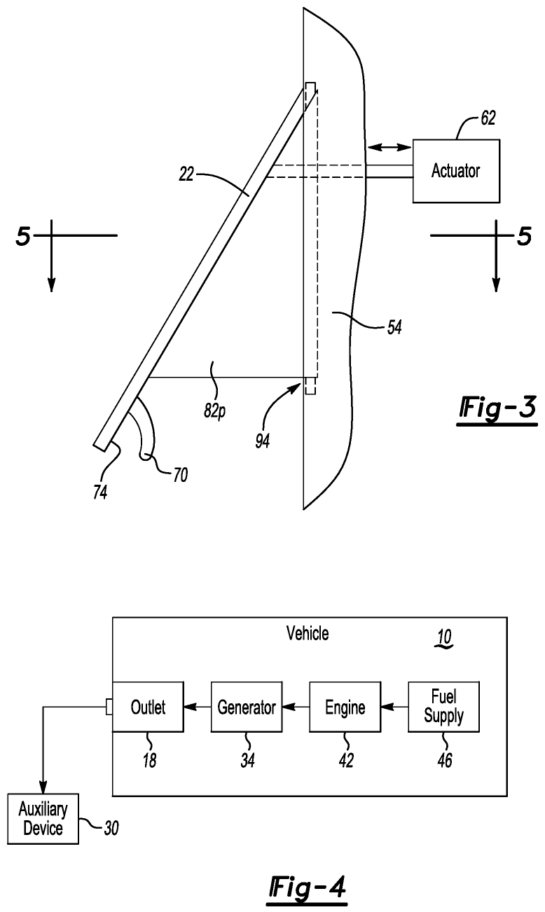

FIG. 3 shows, schematically, that the exemplary vehicle 10 includes a generator 34, an engine 42, and a fuel supply 46. The engine 42 is an internal combustion engine that burn fuel from the fuel supply 46 to drive the generator 34. The generator 34, when driven, provides power to the outlets 18. The power can be at 220 V, or adjusted to another voltage.

The vehicle 10 could include DC/DC converter used to convert a voltage of DC from a first level to a different, second level. The vehicle 10 could, instead, or additionally include other types of electronic circuits or electromechanical devices used to adjust power from the generator 34 to desired levels for use at the outlets 18.

In another example, the generator 34 is driven using battery power. For example, the vehicle 10 in another embodiment, could be an electrified vehicle having a traction battery. In such an example, the traction battery could provide power to drive the generator 34 instead of, or in addition to, being driven by the engine 42. The traction battery could also provide power to the outlet without requiring the generator.

The generator 34 can refers to any power generating device on the vehicle 10 that is used to provide power to the outlet 18. For example, the generator 34 can be an alternator powered by a 12 V accessory battery of the generator 34. In another example, the generator 34 is part of a hybrid powertrain of the vehicle 10.

In the exemplary, non-limiting embodiment, the outlet assembly 14 is mounted in an upper area of the vehicle 10 at an interface I between a moveable panel 50 of the vehicle 10 and a stationary panel 54 of the vehicle 10.

For purposes of this disclosure, moveable panels are body panels of the vehicle 10 that can be moved and articulated while the other portions of the vehicle 10 remain stationary. The movement could be rotation about a hinge. The fixed panels are the body panels of the vehicle 10 that are not intended to move when the vehicle 10 is moving, or parked and stationary. The exemplary moveable panel 50 is a liftgate, which can be opened to access a cargo area of the vehicle 10.

Placing the outlet assembly 14 at the interface I between the moveable panel 50 and the stationary panel 54 can facilitate assembly and manufacturability as substantial modifications to body panels are not required for the vehicle 10 to incorporate the outlet assembly 14. In a vehicle that does not include the outlet, the area designated for optionally accommodating the outlet assembly 14 can be covered by extending a trim panel 58 (FIG. 2) or by adding a new trim panel to cover the space that optionally accommodates the outlet assembly 14. This approach substantially avoids the need to customize body panels for both vehicles with and without an outlet assembly.

In other examples, the outlet assembly 14 could be positioned as, for example, within an area extending from a rear tail lamp, or within an area extending from a rear quarter window. If a vehicle is not to include the outlet assemblies, the areas of extension can be covered with a trim panel,

The outlet assembly 14 of the exemplary embodiment is located in a vertically upper area of the vehicle 10, which can help to keep the outlets 18 cleaner than if, for example, the outlet assembly 14 were located in a vertically lower area of the vehicle 10 closer to contaminants along a road surface. The vertically upper area of the vehicle 10 generally corresponds to areas of the vehicle 10 that are vertically above the beltline B. Vertical, for purposes of this disclosure, is with reference to ground and the ordinary orientation of the vehicle 10 during operation.

The outlets 18 of the outlet assembly 14 are tipped downward at an angle. Accordingly, moisture drains from the outlets 18 rather than further into the outlets 18. Other contaminants, such as dust and dirt, are also less likely to enter the outlets 18 due to the downward angle. As the example outlet assembly 14 is in a vertically upper area of the vehicle 18, angling the outlets 18 downward can additionally facilitate the user coupling the plug 26 to one of the outlets 18.

The cover 22 can be moved from the accessing position shown in FIGS. 1-3 to a covering position where the cover 22 conceals the outlet 18. When the cover 22 is in the accessing position, the outlets 18 are revealed such that the user can insert the plug 26 into one of the outlets 18. When the cover 22 is in the covering position, the cover 22 blocks wind, rain, snow, and other contaminants from contacting the outlets 18. The cover 22 can thereby help to keep the outlets 18 clean. The cover 22 is typically in the covering position when the vehicle 10 is driven, when the outlets 18 are not in use, or both.

In the exemplary embodiment, the cover 22 is moveable between the back and forth between the covering and accessing positions by pivoting between the covering and accessing positions about a cover pivot axis A_{cover} that is vertically above the outlets 18. In another example, the cover pivots axis A extends along a side of the outlets 18.

The user can manually move the cover 22 back and forth between the covering position and the accessing position. Instead, or additionally, an actuator 62 (FIG. 3) can be used to automatically move the cover 22 back and forth between the covering position and the accessing position.

The actuator 62 could automatically move the cover 22 in response to a command initiated by the user through an interface of the vehicle 10, or through a mobile device, such as a smart phone. The actuator 62 could instead or additionally move the cover 22 in response to a sensor, such as a sensor 66 (FIG. 1), detecting the user. The sensor 66 could, for example, be a proximity sensor that detects the presence of the user near the rear of the vehicle 10 and thus near the outlet assembly 14. The sensor, in other examples, could be an ultrasonic sensor, such as an ultrasonic backup sensor, or a camera.

The actuator 62 could also move the cover from the accessing position back to the covering position in response to the sensor 66 failing to detect the user. The sensor 66 not detecting the user could indicate that the user has left the area near the rear of the vehicle 10. Moving the cover 22 automatically back to the covering position can help to protect the outlets 18 when the outlets 18 are not in use.

In the exemplary, non-limiting embodiment, a cord hook 70 extends from an underside 74 of the cover 22. When the plug 26 is engaged with the outlet 18, a cord 78 coupling the plug 26 to the auxiliary device 30 can be draped over the cord hook 70 to provide support for the cord 78 and to keep the cord 78 away from the vehicle 10. Supporting the cord 78 can be particularly useful if the cord 78 is a relatively heavy cord, such as 220 Volt cord. The cord 78, if unsupported could pull on the plug 26 causing the plug 26 to disengage from the outlet 18. In other examples, the cord hook 70 could extend from the outlet 18 or an area surrounding the outlet 18.

With reference to FIGS. 2-5, a pair of side shields 82 extends from the cover 22, and are disposed between the cover 22 and the outlets 18 when the cover 22 is in the accessing position. The cover 22 is generally disposed along a plane, and the sides shields 82 extend transversely from the plane of the cover 22. When the cover 22 is in the accessing position, the side shields 82 extend transversely from the cover 22 to the outlets 18. One of the shields 82p is on a passenger side of the outlets 18. The other shield 82d is on a driver side of the outlets 18. Another embodiment may omit one of the shields, such that only the shield 82p is used, for example.

The shields 82p and 82d can help to protect the outlets 18 from wind, rain, snow, and other contaminants when the cover 22 is in the accessing position. In some examples, the cord hook 70 could extend from one of the shields 82p and 82d.

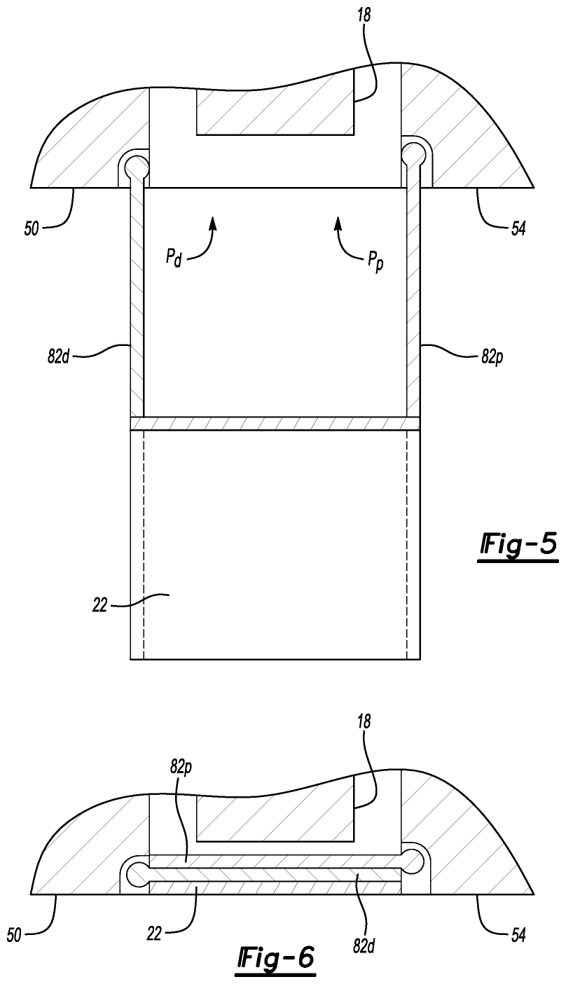

With reference to FIG. 5, the shield 82p is configured to pivot in a direction Pₚ about a shield axis on a passenger side of the outlets 18, and the shield 82d is configured to pivot in a direction Pd about a shield axis on a driver side of the outlets 18. The shield axes on the passenger and driver sides extend vertically in this example.

As the cover 22 is moved from the accessing position of FIG. 5 to the covering position of FIG. 6, the shield 82p pivots inward in the direction Pₚ and the shield 82p pivots inward in the direction Pd so the shields 82p and 82d are folded over the outlets 18.

When the cover 22 is moved back from the covering position to the accessing position, the shields 82p and 82d fold outward to the position of FIG. 5. The shields 82p and 82d could be biased to pivot outward by springs, for example.

Detents could be molded into the shields 82p and 82d to facilitate holding the shields 82p and 82d in the position of FIG. 5. Other detents could be molded into the shields to facilitate holding the shields in the position of FIG. 6.

With reference to FIG. 7, in another exemplary embodiment, shields 182p and 182d are molded together with the cover 122 as a single, unitary structure. The shields 182p and 182d do not pivot relative to the cover 122. The shields 182d and 182p instead pivot with the cover about the cover pivot axis A_{cover} when the cover 122 moves back and forth between the covering position and the accessing position.

When the cover 122 is in the covering position, the shields 182d and 182p are received within respective slots. A slot 186d that receives the shield 182p is shown in broken lines in FIG. 7. The slots are within the vehicle and provide clearance for the shields 182d and 182p so that the cover 122 is able to move to the covering position. Moving the cover 122 back to the accessing position withdraws the shields 182d and 182p from the slots.

The slots 186d, 186p could include floors that taper downward moving outward away from the vehicle, which can help to reduce dust and moisture building up within the slots 186d, 186p. An example floor 190p is shown in as a floor of the slot 186p.

The slots 186d, 186p could be designed as cavities in a plastic panel, or, if open, can be sealed by slit or flap foam or rubber or similar to keep out noise. In some examples, the slots 186d, 186p could provide part of an air extractor system for the vehicle. The air extractor permits air to flow between the interior of the vehicle and the exterior of the vehicle to, among other things, balance pressures.

With reference now to FIGS. 1, 2, 4, and 8, the vehicle 10 can include a control module 200 used to control various features associated with the outlet assembly 14 and the overall vehicle 10. The control module 200 can include, among other things, a processor and a memory portion. The processor can be programmed to execute a program stored in the memory portion. The processor can be a custom made or commercially available processor, a central processing unit (CPU), an auxiliary processor among several processors associated with the control module 200, a semiconductor based microprocessor (in the form of a microchip or chipset) or generally any device for executing software instructions.

The memory portion can include any one or combination of volatile memory elements. Programs can be stored in the memory portion as software code and used to selectively activate various components of the vehicle 10 and other devices. The programs can include one or more additional or separate programs, each of which includes an ordered list of executable instructions for implementing logical functions associated with commanding the various components.

For example, the control module 200, in response to the sensor 66 detecting the user, can commands the actuator 62 to move the cover 22 from the covering position to the accessing position.

In another example, the outlet assembly 14 can include a lightable area 94 near the outlets 18. The lightable area 94 could be provided by Light Emitting Diodes (LEDs). The LEDs could be Red Green Blue (RGB) LEDs in some examples.

The control module 200 can cause the lightable area 94 to illuminate in varying patterns, intensities, colors, etc. to provide visual notifications to the user. The visual notifications could indicate that the one or both of the outlets 18 is providing power, for example. The visual notifications could indicate that the plug 26 is or is not properly coupled to the outlet 18 by, for example, illuminating in green when the plug 26 is properly engaged, and illuminated in red when the plug 26 is not properly engaged. The control module 200 could command the lightable area 94 to illuminate to increase visibility in the area surrounding the outlet assembly 14, which could help the user see in low light conditions.

The control module 200 could command vehicle lights 98, such as tail lights or backup lights, to turn on to illuminate an area at the rear of the vehicle 10, which may be a work area for the user. Illuminating this area could improve visibility for the user.

The control module 200, in some examples, commands the lights to turn on when the cover 22 is in the accessing position, when power is moving through at least one of the outlet assembly 14, or both. In such an example, even though the vehicle 10 may be keyed off and the gear shift in park, the control module 200 can automatically turns on the lights in response to conditions relating to the outlet assembly 14.

A cover position sensor 102 could provide a signal to the control module 200 that the control module 200 uses to assess whether or not the cover 22 is in the accessing position. Another sensor could provide signals to the control module 200 that the control module 200 uses to assess power flow through the outlets 18 of the outlet assembly 14.

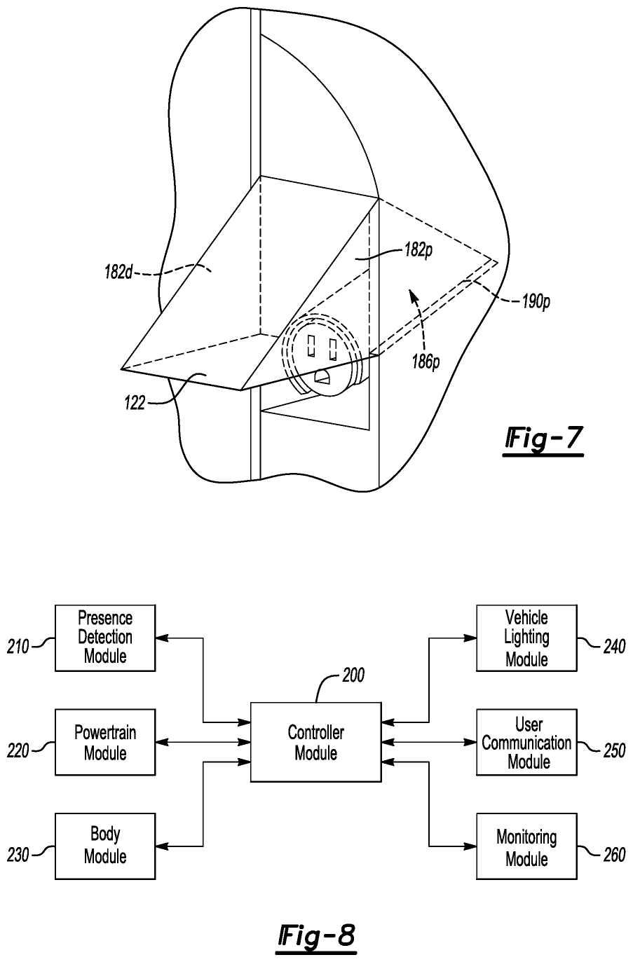

Referring to FIGS. 1, 2, 4, and 8, the block diagram of FIG. 8 illustrates, in schematic form, how the control module 200 may relate to other portions of the vehicle 10 and other devices. As previously described, the control module 200 can receive, as inputs, information relating to detecting the user being near to the vehicle 10. These inputs are represented in box 210 as presence detection. The sensors 66 of the vehicle 10 can provide these inputs in some examples. In some examples, the control module 200 can send a command to the sensors 66 requesting a detection of the user.

The control module 200 can further receive inputs from a powertrain module 220 and a body module 230. Exemplary inputs to the control module 200 from the powertrain module 220 can include current readings, engine temperatures, gear positions, etc. The control module 200 can control aspects of the powertrain module 220. The control module 200 can command the generator 34 to generate more power, for example.

Exemplary inputs to the control module from the body module 230 can include inputs from a user device antenna that detects user devices, such as Bluetooth Low Energy (BLE) devices. Such inputs could include the antenna detecting a BLE device associated with the user—a telephone, for example. The detection of the user device can include information about how far the user device is from the vehicle 10, and an angle of the user device relative to the vehicle 10, etc.

Another input from the body module 230 could be an input from a key fob antenna that detects key fobs. The input could indicate that the key fob antenna has detected a key fob associated with the vehicle 10 in close proximity to the vehicle 10. The input could further include information about the distance and angle of the key fob relative to the vehicle 10.

Yet another input from the body module 230 could include an amount of fuel in the fuel supply 46 of the vehicle 10.

In this example, the control module 200 can send commands to the body module 230 to control aspects of the body module 230. The control module 200 can command the body module 230 to provide a reading of the amount of fuel in the fuel supply 46, for example.

The control module 200 can command, in this example, vehicle lights to turn on or off. A vehicle lighting module 240 represents the vehicle lighting, which could include the lightable area 94 of the outlet assembly 14, the vehicle lights 98, or other lights of the vehicle 10.

The control module 200 could, for example, command the backup lights and/or other vehicle lights to flash in response to a level of fuel in the fuel supply 46 dropping below a threshold level, which could correspond to an amount of fuel that the engine 42 requires to drive the vehicle 10 to a desired location, say fifty miles. The flashing of the lights notifies the user of the fuel level so the user can, if desired, stop drawing power through the outlets 18. This stops the user of fuel to power the generator 34 so that the vehicle 10 has enough fuel to return to the desired location.

The control module 200 can communicate with the user in some examples, via messages, such as alerts. These communications are represented as a user communication module 250.

In an exemplary embodiment, the messages are provided for the user on a display. The display can be a display of the vehicle 10, a display of a user device, or some other type of display. The messages could be alphanumeric, could include icons, or other types of indicators, such as lit or unlit icons.

Example messages can notify the user of a time remaining that the vehicle 10 can continue to provide power through the outlet 18. The time remaining can be based on a level of fuel in the fuel supply 46. If instead a battery is powering the generator, the time remaining can be based on an amount of charge remaining in the battery. The time remaining can decrease as power is provided through the outlet 18.

Another example message reveals the characteristics of the power provided through the outlet 18, such as electrical load, amperage, power level, etc. The control module 200 could retrieve this information from the powertrain module 220. Another exemplary message could indicate the status of a Ground Fault Interrupter (GFI) associated with the outlet assembly 14.

The user can communicate commands to the control module 200 for controlling various features via the display, for example. The user can, from the display initiate a load restriction feature that reduces the load from the generator 34 to extend a running time of the generator 34. The control module 200 receives this command from the user communication module 250 and relates the command to the powertrain module 220 to alter the operation of the generator.

The user could, in some examples, send commands causing the control module 200 to adjust the vehicle lights 98. The user could, for example, turn up an intensity of the backup lights to enhance visibility in a work area at the rear of the vehicle 10.

The user could send commands causing the control module 200 to further engage a movement illumination feature. In some examples, the movement illumination feature includes automatic lighting turn on. For examples, the control module 200 may monitor signals from monitor backup sensors or cameras of the vehicle, and then turn on backup lights for two minutes when movement is detected. Ultrasonic backup sensors can be monitored to detect movement and backup lights can automatically be turned on to illuminate an area near the rear of the vehicle, which allows a user to have lighting to plug/unplug devices to the outlets, and to prevent the user from tripping over cords.

In another example, if the vehicle 10 is configured such that the generator 34 is operable only when the vehicle 10 is in a parking gear, the user may interact send a command to override this feature so that the generator 34 is operable when the vehicle 10 is not in the parking gear.

The control module 200 can control various other features of the vehicle 10 relating to monitoring. These features are represented as a monitoring module 260. Exemplary monitoring features could include illuminating an indicator within an instrument cluster of the vehicle 10 when the cover 22 in the in accessing position, or when the cover 22 is in the covering position.

In some examples, the control module 200 can help to prevent theft of power through the outlet assembly 14 by requiring an authorized user to be in proximity of the vehicle 10 in order to send power to the outlet assembly 14 or in order to move the cover 22 to the accessing position.

Authorizing the user can include monitoring areas around the vehicle 10 to ensure that an authorized device, such as a BLE cellular phone or key fob, remains in close proximity to the vehicle 10, say within ten feet of the vehicle 10. If the authorized device is not within the area around the vehicle 10, the control module 200 will not permit power to move from the generator 34 through the outlet assembly 14.

If the authorized device is in the area around the vehicle 10, but then leaves the area while the generator 34 is providing power through the outlet assembly 14, the control module 200 may automatically shut down the generator 34. The control module 200 could also initiate an alert to the displays or authorized devices notifying the user that the generator 34 has shut down. The alert could be send via BLE or WiFi, for example.

Exemplary status and safety features provided by the control module 200 and monitoring module 260 can include controlling the lighting of the lightable area 94. The lighting of the lightable area 94 can provide guidance for the user by communicating a generator fuel status (red/yellow/green) and circuit heath (e.g., fault indication by rapid flashing, etc.)

Another safety and status feature could enable a user to determining a status of the outlet assembly 14 from a distance away from the vehicle 10, say one hundred feet. In examples of such features, the backup lights could flash once every thirty seconds to indicate that power is flowing from the generator 34 to the outlet assembly 14. The taillights could flash when a problem exists such as when fuel is running low, GFI has tripped, etc. In some examples, a horn of the vehicle 10 could continually chirp to indicate problem an issue with the outlet and associated devices.

Another safety feature provided by the control module 200 and other modules could prevent the vehicle 10 from being shifted into a driving gear if power is moving from the generator 34 to the outlet assembly 14. The vehicle 10 could instead or additionally be prevented from shifting into a driving gear when the cover 22 is not in the covering position.

The control module 200 and other modules can, in some examples, permit the user to reset a GFI associated with the outlet via an interface within the vehicle 10 or an interface on a user device, a touch screen interface, for example.

The control module 200 and other modules can, in some examples, can help to control the generator 34 and to prevent overloading of the generator 34. A display, for example, can provide the user with an opportunity to select a particular power level for the generator 34 by selecting a number of amps, for example. If the generator 34 exceeds the selected power level, the control module 200 can initiate an alert, such as the vehicle lights flashing, the horn chirping, etc.

The control module 200 and other modules can provide alerts the user in response to a temperature of the generator 34 exceeding a threshold temperature. The alert can be provided if the temperatures are such that an over-temperature condition is expected within a set time period, say within 30 minutes.

The control module 200 and other modules can provide an alert to the user indicating an estimated run time for the generator 34 based on an amount of fuel remaining in the vehicle 10 to power the generator 34, or an amount of energy remaining in a battery that powers the generator 34. The alert can include displaying an amount of generator run time remaining based on a load on the generator 34. The alert can be broadcast to a user device, displayed within the vehicle 10, or both.

The control module 200 and other modules can automatically shut off the generator 34 to prevent fuel depletion. If the vehicle 10 includes a battery powering the generator, the control module 200 and other modules can automatically shut off the generator to prevent energy depletion of the battery. In connection with the automatic shutoff, the control module 200 may provide the user with an option to override the automatic shutoff.

The control module 200 and other modules can place the vehicle 10 in an extended run time mode that can increase a potential operating time for the generator 34. The extended run time mode can include putting electronics of the vehicle 10 into a sleep mode to maximize power available for the generator 34 to provide to the outlet assembly 14.

The control module 200 and other modules can provide an alert that graphs the load. For example, the amount of power being drawn through the outlet assembly 14 can be periodically transmitted, say every 10 seconds, to the user device or displayed within the vehicle 10.

The control module 200 and other modules can command vehicle lights in response to inputs from the user. For example, the intensity of the backup lights can be varied in response to the control module 200 receiving an input from a user.

The control module 200 and other modules can command the vehicle lights 98 to turn on automatically in response to movement being detected about the vehicle. Backup sensors, cameras, etc. could be used to detect such movement. Once turned on, the vehicle lights 98 can stay on for a time period, say two minutes, and then turn off if no further movement is detected.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle outlet assembly, comprising:
an outlet mounted to a vehicle;
a cover moveable between a covering position where the cover conceals the outlet and an accessing position where the cover reveals the outlet; and
at least one side shield that extends transversely from the cover to the outlet when the cover is in the accessing position.

2. The vehicle outlet assembly of claim 1, wherein the cover is configured to pivot between the covering and accessing positions about a cover pivot axis that is vertically above the outlet, wherein the at least one side shield includes a side shield configured to pivot about a shield axis on a passenger side of the outlet, and a side shield configured to pivot about a shield axis on a driver side of the outlet.

3. The vehicle outlet assembly of claim 1, wherein the at least one side shield is at least partially received within a slot of the vehicle when the cover is in the covering position.

4. The vehicle outlet assembly of claim 1, wherein the at least one shield includes a first shield on a passenger side of the outlet and a second shield on a driver side of the outlet.

5. The vehicle outlet assembly of claim 1, further comprising a cord hook extending from an underside of the cover.

6. The vehicle outlet assembly of claim 1, wherein the outlet is positioned on the vehicle at an interface between a moveable panel of the vehicle and a stationary panel of the vehicle.

7. The vehicle outlet assembly of claim 6, wherein the moveable panel is a liftgate of the vehicle.

8. The vehicle outlet assembly of claim 1, further comprising lights of the vehicle, the lights are configured to indicate a status of the outlet.

9. The vehicle outlet assembly of claim 1, further comprising a plurality of backup lights of the vehicle, the backup lights configured to illuminate when power is provided to the outlet.

10. The vehicle outlet assembly of claim 1, further comprising a controller module configured to initiate a transmission of an alert that provides an indication to a user of available power that can be drawn through the outlet.

11. The vehicle outlet assembly of claim 1, further comprising a controller module configured to cause an interruption in power flow to the outlet in response to an amount of fuel in the vehicle being reduced to below a threshold value.

12. The vehicle outlet assembly of claim 1, wherein the outlet is a 220 Volt outlet.

13. A power providing method, comprising:
powering a device through an outlet of a vehicle; and
illuminating an area associated with the device during the powering using at least one light of the vehicle.

14. The power providing method of claim 13, wherein the at least one light is a backup light of the vehicle.

15. The power providing method of claim 13, further comprising stopping the powering in response to an amount of fuel being reduced below a threshold value that is greater than zero.

16. The power providing method of claim 13, further comprising stopping the powering in response to an amount of charge in a battery being reduced below a threshold value that is greater than zero.

17. The power providing method of claim 13, further comprising alerting a user in response to an amount of power available for powering being reduced to below a threshold value that is greater than zero.

18. The power providing method of claim 13, wherein the illuminating is in response to the powering.

19. The power providing method of claim 13, further comprising transmitting an alert that provides an indication to a user of available power that can be drawn through the outlet.

20. The power providing method of claim 13, further comprising, prior to the powering, moving a cover from a covering position where the cover conceals the outlet to an accessing position where the cover reveals the outlet, wherein at least one side shield extends transversely from the cover to the outlet when the cover is in the accessing position.
